(19) United States
(12) Patent Application Publication
(10) Pub. No.: US 2016/0027006 A1
(43) Pub. Date: Jan. 28, 2016

(54) ENCRYPTING PIN RECEIVER

(71) Applicant: Diebold Self-Service Systems, Division of Diebold, Incorporated, North Canton, OH (US)

(72) Inventor: Nicholas BILLETT, JR., Massillon, OH (US)

(21) Appl. No.: 14/807,138

(22) Filed: Jul. 23, 2015

Related U.S. Application Data
(60) Provisional application No. 62/027,949, filed on Jul. 23, 2014.

(51) Int. Cl. G06Q 20/38; G06Q 20/32; H04L 9/32; H04W 12/06; H04W 12/04; G06Q 20/40; H04L 29/06

(52) U.S. Cl. CPC G06Q 20/3829; G06Q 20/4012; G06Q 20/3278; H04L 63/0492; H04W 12/06; H04W 12/04; H04L 9/3271

(57) ABSTRACT

In an example embodiment, an encrypting personal identification number (PIN) receiver operable to receive a PIN from a source via a contactless interface. The PIN is decrypted with a key associated with the source, and subsequently encrypted with a key associated with a destination for the PIN. The PIN encrypted with the key associated with the destination is forwarded towards the destination via a second interface.

### CROSS REFERENCE TO RELATED APPLICATIONS

This application claims the benefit under 35 U.S.C. §119(e) of U.S. Provisional Application No. 62/027,949, filed Jul. 23, 2014.

### TECHNICAL FIELD

The present disclosure relates generally to automated banking machines.

### BACKGROUND

Automated banking machines, such as Automated Teller Machines (or “ATMs”) allow a consumer to perform a variety of financial transactions. The consumer provides data representative of a personal account number (“PAN”) associated with the user and/or with financial accounts associated with the user, and a personal identification number (“PIN”) to authenticate with the ATM.

### BRIEF DESCRIPTION OF THE DRAWINGS

The accompanying drawings incorporated herein and forming a part of the specification illustrate the example embodiments.

FIG. 1 is a block diagram illustrating an example of an encrypting PIN receiver.

FIG. 2 is a block diagram illustrating an example of an automated teller machine with an encrypting PIN receiver.

FIG. 3 is a block diagram illustrating an example of an automated teller machine with an encrypting PIN receiver coupled with a Financial Institution Host.

FIG. 4 is a block diagram illustrating an example of a computer system upon which an example embodiment can be implemented.

FIG. 5 is an example signal diagram for illustrating a financial transaction in accordance with an example embodiment.

FIG. 6 is a block diagram illustrating an example of a methodology for receiving a PIN via a contactless interface.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a contactless interface, a second interface, and a processor coupled with the contactless interface and the second interface. The processor is operable to receive data representative of a personal identification number (“PIN”) encrypted by a first key via the contactless interface. The processor is operable to decrypt the data representative of the PIN with a first decryption key. The processor is operable to encrypt the data representative of the PIN with a second encryption key, and the data representative of the PIN encrypted by the second key is transmitted on the second interface.

In accordance with an example embodiment, there is disclosed herein a tangible, non-transitory computer readable medium of execution with instructions for execution by a processor encoded thereon, and when executed operable to detect a contactless device in data communication with a contactless interface. The instructions are further operable to send a customer present event to a controller coupled with a second interface. The instructions are yet further operable to receive a personal identification number (“PIN”) block request from the controller. The instructions are still yet further operable to receive a challenge from the contactless device via the contactless interface. The instructions are operable to send a response to the challenge signed with a predefined key, such as a private key to the contactless device. The instructions are further operable to receive data representative of a session key. The instructions are still further operable to receive data representative of a PIN from the contactless device. The Instructions are yet further operable to receive data representative of a personal account number (“PAN”) from the contactless device. The instructions are still yet operable to decrypt the data representative of the session key, decrypt the data representative of the PIN, decrypt the data representative of the PAN, and send a response to the PIN block request, the response to the PIN block request comprises the data representative of the PIN and data representative of a PAN encrypted by a key established with the controller. The instructions are operable to receive data representative of a transaction encrypted by the session key. The instructions are further operable to decrypt the data representative of a transaction, encrypt the data representative of a transaction with the key established with the controller, and forward the data representative of the transaction encrypted by the key established with the controller to the controller.

In accordance with an example embodiment, there is disclosed herein a method comprising receiving a personal identification number (PIN) via a contactless interface. The method further comprises decrypting the PIN with a first key, encrypting the PIN with a second key, and forwarding the PIN encrypted with the second key onto a second interface.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment described herein, there is disclosed an encrypting PIN (personal identification number) receiver that is operable to receive data representative of a PIN from a contactless device, such as, including but not limited to, a near field communication (NFC) device, a WIFI device, a BLUETOOTH device, an Infrared (IR) device, and/or optical device. The data representative of the PIN is received encrypted with a first key associated with the device sending the data representative of the PIN. The data representative of the PIN is encrypted with a second key associated with a destination for the data representative of the PIN, for example an ATM controller or other device that will validate the data representative of the PIN. The data representative of the PIN encrypted by the second key is forwarded towards the destination via a second interface, which may be a contactless interface, or a wired interface.

In an example embodiment, this can eliminate the need for a PIN pad. Other data may be included with the data representative of the PIN, such as data representative of a personal account number (PAN) and/or data representative of a financial transaction. In particular embodiments, the encrypting PIN pad is located in the interior of a device, such as an ATM or point of sale (POS) terminal which can prevent physical access by unauthorized people.

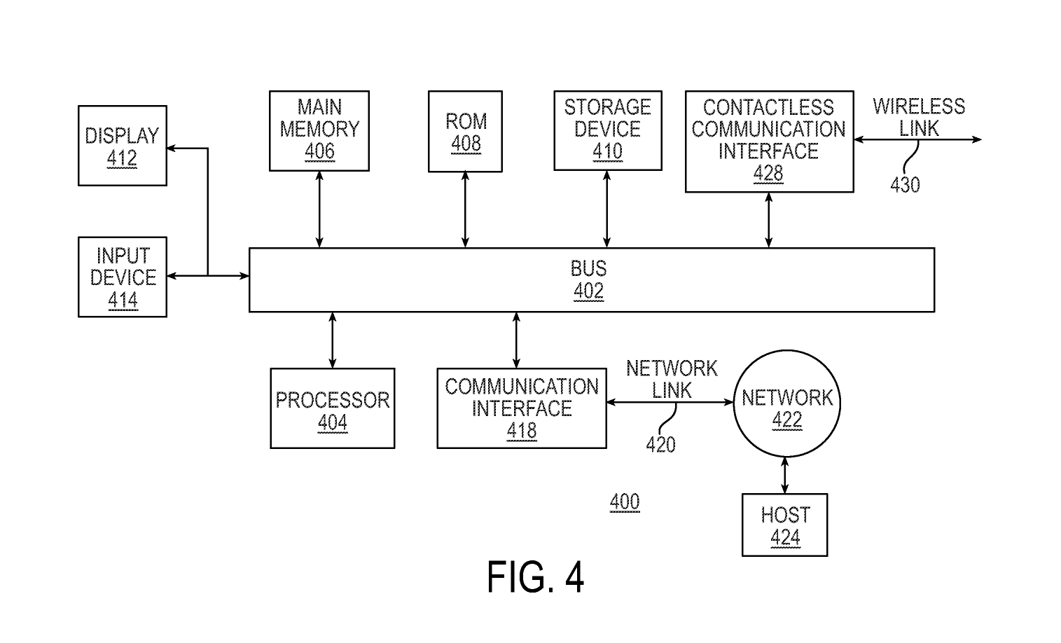

FIG. 1 is a block diagram illustrating an example of an encrypting PIN receiver 100. The encrypting PIN receiver 100 comprises a contactless interface 102 for receiving a PIN from a source device, and a second interface 104 that provides the PIN received from the source to a destination that is encrypted with a key associated with the destination. The encrypting PIN receiver 100 further comprises logic (EPP logic 106), such as a processor (see e.g., FIG. 4), for implementing the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that when executed by a processor performs the functionality described herein.

In an example embodiment, the encrypting PIN receiver 100 receives data representative of a PIN from the source via the contactless (first) interface 102 encrypted by a key associated with the first source that sent the PIN. The contactless interface may be any suitable wireless interface, such as, including but not limited to a near field communication (NFC) interface, a WIFI interface, a BLUETOOTH interface, or any other suitable type of a radio frequency (RF) interface, a infrared (IR) interface, and/or an optical interface.

EPP logic 106 associated with encrypting PIN receiver 100 is operable to decrypt the data representative of the PIN with a first decryption key. The EPP logic 106 is further operable to encrypt the data representative of the PIN with a second encryption key, and transmit the data representative of the PIN encrypted by the second key on the second interface 104. The second interface 104 may comprise any suitable wired and/or wireless interface. For example, the second interface 104 may be a Universal Serial Bus (USB) compatible interface and/or a PCI (personal computer interface) 3.x compatible interface.

In an example embodiment, the first encryption key may be a session key that is established with the device in data communication with the contactless interface. For example, the first encryption key may be a session key established during a challenge/response exchange before the data representative of the PIN is sent. In other embodiments, PKI (Public Key Infrastructure) cryptography may be employed, where a private key associated with the Encrypting PIN receiver 100 is employed as the session key.

In an example embodiment, the encrypting PIN receiver 100 may receive a challenge from the source of the data representative of the PIN that is communication with the contactless interface 102. In particular embodiments, the challenge is send with a public key for the encrypting PIN receiver 100. The encrypting PIN receiver 100 may send a response to the challenge that is signed by a key, such as a public key, for the source that is associated with the contactless interface 102.

Optionally, in particular embodiments, the encrypting PIN receiver 100 is operable to send a signed challenge to the source of the PIN associated with the contactless interface 102 via the contactless interface 102.The encrypting PIN receiver 100 may wait for a response to the challenge, and validate the response to the challenge before accepting data representative of a PIN from the source.

In an example embodiment, the encrypting PIN receiver 100 is operable to detect when a device moves into range of the contactless interface 102. The encrypting PIN receiver 100 may send to a device in data communication with the second interface 104 a customer present event notification responsive to detecting the device in data communication with the contactless interface 102. In particular embodiments, the encrypting PIN receiver 100 is operable to receive a PIN block request from the device in data communication with the second interface 104. In an example embodiment, the data representative of the PIN encrypted by the second key is sent in a PIN block to the device in data communication with the second interface 104 in response to the PIN block request. In particular embodiments, the PIN block may further comprise data representative of a personal account number (PAN) and/or data representative (such as a uniform resource locator “URL”) associated with a financial institution associated with the PAN or where an account for a financial transaction is located.

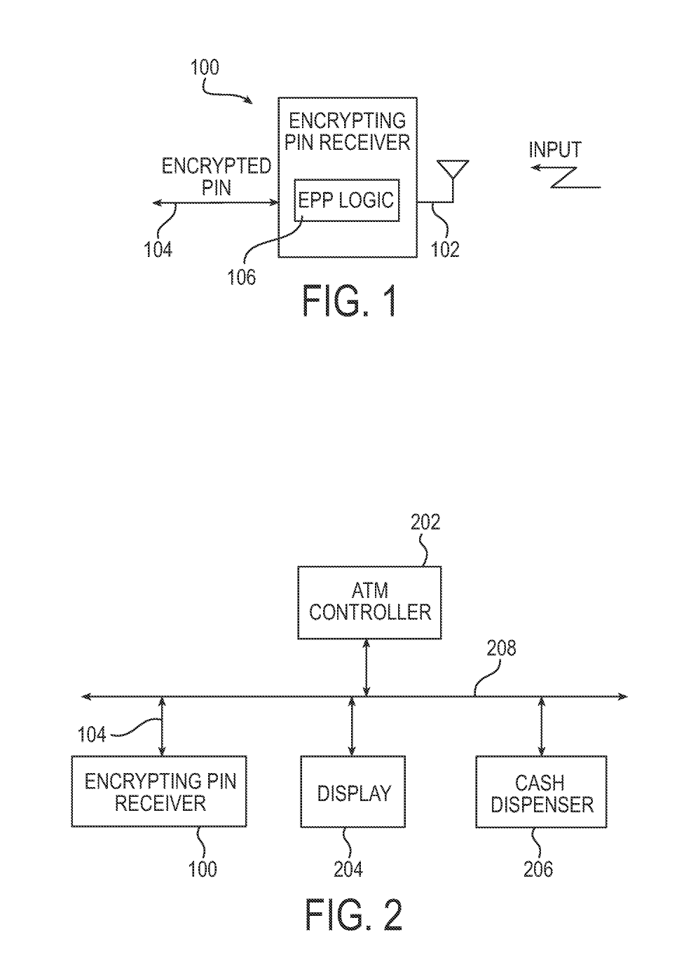

FIG. 2 is a block diagram illustrating an example of an automated teller machine 200 with an encrypting PIN receiver 100. In this example embodiment, the ATM 200 comprises an ATM controller 202 with logic for performing financial transactions, an encrypting PIN receiver 100, a display 204, and a cash dispenser 206. The ATM controller 202, encrypting PIN receiver 100, display 204, and cash dispenser 206 are coupled together via a bus 208. Bus 208 may be any suitable bus, for example a USB or PCI compatible bus.

In operation, the encrypting PIN receiver 100 can detect when a user is present and send a user present notification to the ATM controller 202. The ATM controller 202 may send a PIN block request to the encrypting PIN receiver 100. The encrypting PIN receiver 100 establishes a secure session with a mobile device associated with the user and obtains PAN, PIN, and other data for a financial transaction. The encrypting PIN PAD forwards a PIN block to the ATM controller 202 via bus 208. In an example embodiment, the encrypting PIN PAD receives the PAN, PIN, and other data for a financial transaction encrypted with a session key established with the mobile device associated with the user, decrypts the PAN, PIN, and other data for a financial transaction, and forwards the PAN, PIN, and other data for a financial transaction via bus 208 to ATM controller encrypted with a PIN established between encrypting PIN receiver 100 and ATM controller 202. If the financial transaction involves a cash withdrawal, providing the financial transaction is approved, the ATM controller 202 may send a command to cash dispenser 206 to dispense the cash. ATM controller 202 may output Informational and/or advertising messages on displayed display 204 while the transaction is in progress, and may output a final message at the end of the transaction.

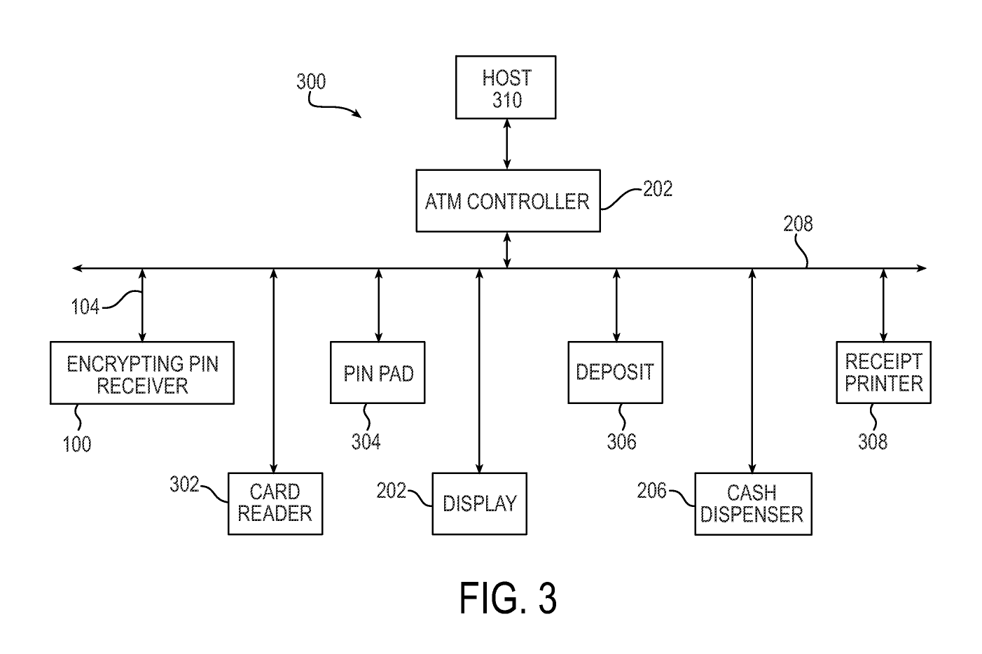

FIG. 3 is a block diagram illustrating an example of an automated teller machine 300 with an encrypting PIN receiver 100 coupled with a Financial Institution Host 310. The ATM 300 in this example optionally includes a card reader 302 and a PIN pad 304. In particular embodiments, the card reader 302 and PIN pad 304 are communicatively coupled with encrypting PIN receiver 100. Thus, encrypting PIN receiver may provide PAN and PIN data to the ATM controller 202 whether the data is received via a contactless interface (e.g., interface 102 in FIG. 1) as described herein or if the data is received from card reader 202 and PIN pad 304. In an example embodiment, where display 202 is a touch screen display, the PIN pad 304 may be embodied on display 202.

In the illustrated example, the ATM 300 further comprises a deposit device that may be operable to receive cash and or other items such as checks. In particular embodiments, the ATM 300 may have multiple deposit devices 306, for example one deposit device for accepting cash and another deposit device for accepting checks or other items. The ATM 300 further comprises receipt printer 308 which may print receipts.

In operation, if PAN, PIN, and transaction data is received via a wireless interface associated with encrypting PIN receiver 100, the ATM controller forwards the data representative of the transaction and any other pertinent data to the host 310, which authorizes or declines the transaction.

If the transaction is authorized, the ATM controller 202 may instruct cash dispenser 206 to dispense the appropriate amount of cash, and optionally instruct receipt printer 308 to print a receipt for the transaction. If the transaction is initiated using card reader 302 and PIN pad 304, which may also be an encrypting PIN pad or “EPP”, the ATM controller may output a menu on display 202 and obtain inputs to acquire data representative of the transaction. The ATM controller 202 then forwards data representative of the requested transaction to the host 310. The host 310 either authorizes or declines the transaction and communicates the decision to ATM controller 202.

FIG. 4 is a block diagram illustrating an example of a computer system 400 upon which an example embodiment can be implemented. For example, computer system 400 can be employed to implement the functionality of the EPP logic associated with the encrypting PIN receiver 100 described in FIG. 1.

Computer system 400 includes a bus 402 or other communication mechanism for communicating information and a processor 404 coupled with bus 402 for processing information. Computer system 400 also includes a main memory 406, such as random access memory (RAM) or other dynamic storage device coupled to bus 402 for storing information and instructions to be executed by processor 404. Main memory 406 also may be used for storing a temporary variable or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412 such as a cathode ray tube (CRT) or liquid crystal display (LCD), for displaying information to a computer user. An input device 414, such as a keyboard including alphanumeric and/or other keys is coupled to bus 402 for communicating information and command selections to processor 404. Another type of user input device is a touch screen display where the user touches certain area of the display 412 to input data.

An aspect of the example embodiment is related to the use of computer system 400 for an encrypting PIN receiver. According to an example embodiment, the Encrypting PIN receiver is provided by computer system 400 in response to processor 404 executing one or more sequences of one or more instructions contained in main memory 406. Such instructions may be read into main memory 406 from another computer-readable medium, such as storage device 410. Execution of the sequence of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 404 for execution. Such a medium may take many forms, including but not limited to non-volatile media, volatile media, and transmission media. Non-volatile media include for example optical or magnetic disks, such as storage device 410. Volatile media include dynamic memory such as main memory 406. Transmission media include coaxial cables, copper wire and fiber optics, including the wires that comprise bus 402. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 404 for execution. For example, the instructions may initially be borne on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406 from which processor 404 retrieves and executes the instructions. The instructions received by main memory 406 may optionally be stored on storage device 410 either before or after execution by processor 404.

Computer system 400 also includes communication interfaces 418 and 428 that are coupled to bus 402. Communication interfaces 418 provides a two-way data communication coupling computer system 400 to a network link 420 that is connected to a host 422. For example, the host 422 may be a controller of an ATM. Communication interface 428 is a contactless interface, such as contact interface 102 in FIG. 1 that is coupled with a wireless link 430.

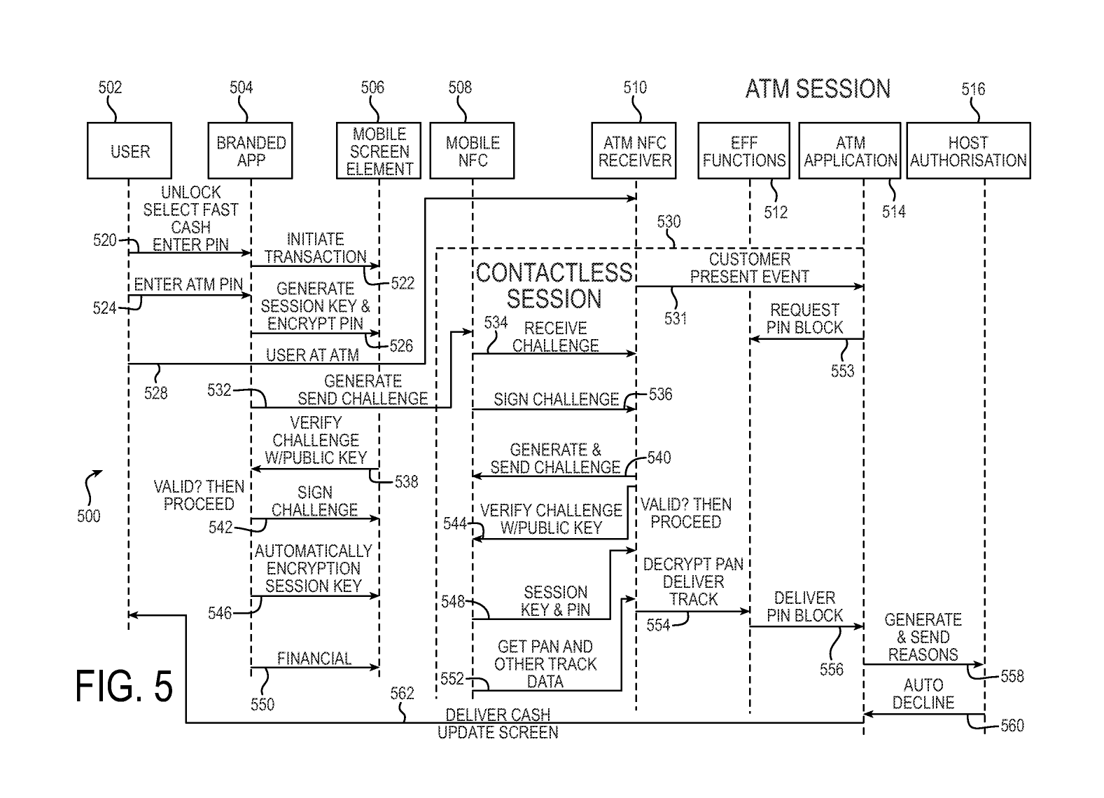

FIG. 5 is an example signal diagram 500 for illustrating a financial transaction in accordance with an example embodiment. In the illustrated example, a user 502 employing an application 504 installed on a mobile device is performing a financial transaction with an ATM. Those skilled in the art should readily appreciate that the principles described herein are suitable for use with other devices/transactions such as POS devices/transactions. The mobile device (not shown) comprises a mobile secure element 506 and a NFC interface 508. The mobile device communicates with an ATM's NFC device 510. The ATM further comprises an encrypting PIN pad (EPP Functions) 512, and is executing an ATM application 514 (for example at the ATM's controller). The ATM is in communication with a Host 516 for performing a financial transaction.

In an example embodiment, a certificate authority (CA) distributes public key/private key pairs to the mobile device and the EPP prior to the transaction. In particular embodiments, the public key/private key pair are unique to the EPP and mobile device (e.g., the public key for the EPP for a first mobile device is different than a secnd public key distributed to a second mobile device). However, those skilled in the art should readily appreciate that any suitable asymmetric or symmetric encryption method may be employed.

At 520, the user 502 unlocks the mobile device and selects a financial transaction, which in this example is a Fast Cash Transaction. The user 502 may also provide a PIN for the application 504. The application 504 on the mobile device initiates the transaction by sending data to the mobile secure element 506 as illustrated by 522.

At 524, the user 502 enters a PIN for the ATM. At 526, the application generates a session key and encrypts the PIN for the ATM.

At 528, the user 502 is in the vicinity of the ATM. The user may have already been in the vicinity of the ATM prior to unlocking the mobile device or may move into the vicinity of the ATM at any time.

At 530, the ATM's NFC device 510 detects that the user is in the vicinity of the ATM. The ATM's NFC device 510 sends a customer present event notification 531 to the ATM application 514.

At 532, the application 504 generates a challenge 532 that is forwarded to the mobile device's NFC device 508. The mobile device's NFC device 508 forwards the challenge to the ATM's NFC device as illustrated by 534.

At 533, the ATM's application 514 sends a PIN block request 533 to the EPP Functions 512. Note that signals 532 and 533 may occur concurrently and/or in a different order that what is illustrated in FIG. 5.

The ATMs NFC device 510 sends a response to the challenge at 536 to the mobile device's NFC device 508. In an example embodiment, the response to the challenge 536 is signed by the ATM's private key. The mobile secure element 506 forwards the challenge to the application 504. The application 504 verifies the challenge with the ATM's public key at 538.

Optionally, in particular embodiments, the ATM may sends a challenge to the mobile device. This is illustrated by 540 where the ATM's NFC device 510 sends a challenge to the mobile device's NFC 508, the mobile device application 508 signs the challenge at 542 with the mobile device's private key, and at 544 the response to the challenge is sent from the mobile device's NFC device 508 to the ATM's NFC device 510 at 544 for verification. The ATM validates the response with the mobile device's public key.

At 546, the application 504 on the mobile device asymmetrically encrypts the session key that is forwarded to the mobile device secure element 506. The mobile device NFC device 508 sends the session key and the data representative of the PIN to the ATM's NFC device 510. The session key and data representative of the PIN may be sent together or sent separately.

At 550, the application 504 sends data representative of the financial transaction to the mobile secure element 506. At 552, the mobile NFC device 508 obtains the personal account number (PAN) and other data for performing the transaction (for example a URL for the financial institution holding the account), and forwards the data representative of the financial transaction and other data for performing the transaction to the ATM NFC device 510. The ATM NFC device 510 decrypts the data representative of the financial transaction and other data for performing the transaction. In an example embodiment, the data is decrypted using the session key established in 548; however, other embodiments may employ PKI encryption.

At 556, the EPP functions 512 delivers the PIN block to the ATM application 514. In an example embodiment, the EPP functions 512 encrypts the PIN Block with a key established between the EPP functions 512 and the ATM application 514 (or the controller executing the ATM application).

The ATM application 514 obtains the data for the transaction from the PIN Block, and at 558 generates and sends a request for the financial transaction to an host authorization application 516 associated with the financial institution where the financial account resides. At 560, the host authorization application 516 sends a reply (e.g., authorized or declined) to the ATM application 514. If the application was approved, the ATM application may deliver cash to the user 502 as illustrated by 562. The ATM's display is also updated (e.g., if the transaction was authorized the user 502 may be instructed to retrieve the cash, or if the transaction was declined a message indicating the transaction was declined can be displayed).

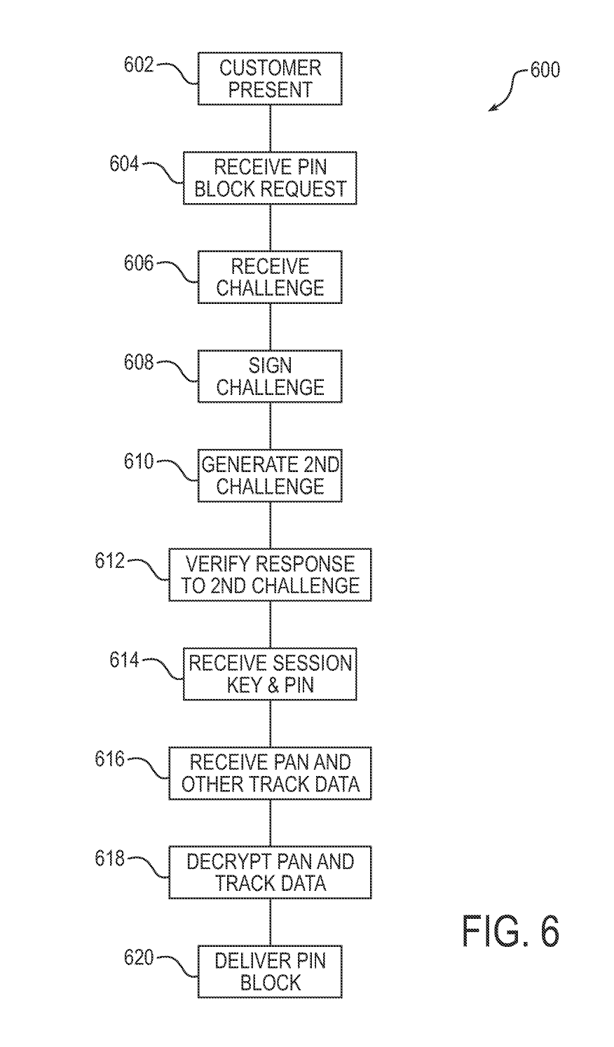

In view of the foregoing structural and functional features described above, a methodology 600 in accordance with an example embodiment will be better appreciated with reference to FIG. 6. While, for purposes of simplicity of explanation, the methodology of FIG. 6 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment. The methodology 600 described herein is suitably adapted to be implemented in hardware, software when executed by a processor, or a combination thereof. Methodology 600 may be implemented by EPP logic 106, (FIG. 1), processor 404 (FIG. 2), and/or the ATM NFC device 510 (FIG. 5).

At 602, a customer is detected within communication range of the device performing the transaction (e.g., an ATM's transceiver (such as a NFC transceiver) range). The customer may start the transaction while within the communication range of the ATM, or may launch a mobile application and start the transaction while outside the communication range of the ATM and subsequently move within range of the ATM.

At 604, a PIN block request is received. In an example embodiment, the PIN Block request is received from an ATM controller.

At 606, a challenge is received from a mobile device from a wireless (e.g. contactless) interface to initiate the transaction with the ATM. At 608, the ATM signs the challenge and transmits the signed challenge to the mobile device. Optionally, at 610, the ATM may generate a second challenge that is sent to the mobile device. A response to the second challenge is received and verified at 612.

At 614, the session key and PIN are received. They may be received together (e.g., encrypted by the ATM's public key), or separately (for example the session key may be received encrypted by the ATM's public key and the PIN is received encrypted by the session key).

At 618, PAN and other data for performing the transaction are received encrypted by the session key. The other data for performing the transaction may include, but is not limited to, data identifying the financial institution (e.g., a URL for the financial transaction), the type of transaction (e.g., cash withdrawal), and the amount of the transaction. The PAN and other data for performing the transaction is decrypted with the session key.

At 620, the PIN Block is generated and sent to the ATM controller In an example embodiment, the PIN Block may include the PAN, the PIN, data identifying the financial institution, transaction type, and amount. In an example embodiment, the PIN block is encrypted with a (second) key that was established between the Encrypted PIN pad receiver and the ATM controller.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
a contactless interface;
a second interface; and
a processor coupled with the contactless interface and the second interface;
wherein the processor is operable to receive data representative of a personal identification number (“PIN”) encrypted by a first key via the contactless interface;
wherein the processor is operable to decrypt the data representative of the PIN with a first decryption key;
wherein the processor is operable to encrypt the data representative of the PIN with a second encryption key; and
wherein the data representative of the PIN encrypted by the second key is transmitted on the second interface.

2. The apparatus set forth in claim 1, wherein the contactless interface is a near field communication interface.

3. The apparatus set forth in claim 1, wherein the contactless interface is a WIFI interface.

4. The apparatus set forth in claim 1, wherein the contactless interface is a BLUETOOTH interface.

5. The apparatus set forth in claim 1, wherein the first encryption key is a session key established with a device in data communication with the contactless interface.

6. The apparatus set forth in claim 5, wherein the first decryption key is the session key.

7. The apparatus set forth in claim 5, wherein the first decryption key is a private key corresponding to the session key.

8. The apparatus set forth in claim 5, wherein the processor is operable to receive a challenge from the device in data communication with the contactless interface;
wherein the processor is operable to respond to the challenge, the response to the challenge is signed by a public key associated with the contactless interface; and
wherein the processor is operable to send the signed challenge to the device associated with the contactless interface via the contactless interface.

9. The apparatus set forth in claim 8, wherein the processor is operable to generate a second challenge;
wherein the processor is operable to send the second challenge to the device in data communication with the contactless interface via the contactless interface;
wherein the processor is operable to receive a response to the second challenge via the contactless interface; and
wherein the processor is operable to verify the challenge with a public key associated with the device in data communication with the contactless interface.

10. The apparatus set forth in claim 1, wherein the processor is operable to detect a device in data communication with the contactless interface; and
wherein a customer present event is sent to a controller in data communication with the second interface responsive to detecting the device in data communication with the contactless interface.

11. The apparatus set forth in claim 1, further comprising the processor is operable to receive a PIN block request from a controller in data communication with the second interface.

12. The apparatus set forth in claim 11, wherein data representative of the PIN encrypted by the second key is sent in a PIN block to the controller in response to the PIN block request.

13. The apparatus set forth in claim 12, wherein the PIN block further comprises data representative of a personal account number.

14. A tangible, non-transitory computer readable medium of execution with instructions for execution by a processor encoded thereon, and when executed operable to:
detect a contactless device in data communication with a contactless interface;
send a customer present event to a controller coupled with a second interface;
receive a personal identification number (“PIN”) block request from the controller;
receive a challenge from the contactless device via the contactless interface;
send a response to the challenge signed with a public key associated with the contactless device to the contactless device;
receive data representative of a session key;
receive data representative of a PIN from the contactless device;
receive data representative of a personal account number (“PAN”) from the contactless device;
decrypt the data representative of the session key;
decrypt the data representative of the PIN;
decrypt the data representative of the PAN;
send a response to the PIN block request, the response to the PIN block request comprises the data representative of the PIN and data representative of a PAN encrypted by a key established with the controller;
receive data representative of a transaction encrypted by the session key;
decrypt the data representative of a transaction;
encrypt the data representative of a transaction with the key established with the controller ; and
forward the data representative of the transaction encrypted by the key established with the controller to the controller.

15. The computer readable medium of claim 14, wherein the contactless interface is a near field communication interface.

16. The computer readable medium of claim 14, wherein the response to the PIN block request further comprises data representative of a transaction.

17. The computer readable medium of claim 14, wherein the instructions are further operable to send a challenge to the contactless device.

18. The computer readable medium of claim 17, wherein the instructions are further operable to receive a response to the challenge from the contactless device.

19. The computer readable medium of claim 17, wherein the instructions are further operable to validate the response to the challenge from the contactless device.

20. A method, comprising:
receiving a personal identification number (PIN) via a contactless interface;
decrypting the PIN with a first key;
encrypting the PIN with a second key; and
forwarding the PIN encrypted with the second key onto a second interface.
